(19) United States
(12) Patent Application Publication
(10) Pub. No.: US 2009/0193858 A1
(43) Pub. Date: Aug. 6, 2009

(54) STORM SHUTTER RETENTION BAR

(76) Inventor: Christopher L. Stinson, Pensacola, FL (US)

Correspondence Address: Peter Loffler, P.O.Box 1001, Niceville, FL, 32588-1001, US

(21) Appl. No.: 12/012,905

(22) Filed: Feb. 4, 2008

(51) Int. Cl. E05B 65/00; E06B 5/10

(52) U.S. Cl. 70/77

(57) ABSTRACT

A retention bar holds a shutter in place against a window within a window opening of a building, the retention bar having a first tubular member and a second tubular member that slides within the first member. The retention bar is positioned against a pair of opposing surfaces of the window opening, windward of the shutter, and the two tubular members are locked to one another. A spring loads the two tubular members against the window surfaces. A foot is threadably attached to an end of the first tubular member and provides fine length adjustment of the retention bar. A pair of plates is located on an end of the second tubular member, which plates lay against the window opening surface and the shutter respectively.

### BACKGROUND OF THE INVENTION

1. Field of the Invention

The present invention relates to a retention bar that holds a storm shutter in place against a window within a window opening on a building without the need to penetrate into the building.

2. Background of the Prior Art

In recent years, the hurricane seasons have become more active, producing a higher than average number of storms and at higher categories, on average, on the Stafford-Simpson scale. These tropical system storms, which can cover vast areas, can come ashore and pack a punch onto affected residents especially those living along coastal areas. Fortunately, modern technology allows most tropical systems to be tracked for several days before landfall and also allow, within a reasonable degree of certainty, the predicated area of landfall. As such, people in the affected areas can make preparations to get out of harm's way. Such preparations include securing homes and other buildings and getting to a safe area, either a storm shelter or out of Dodge completely.

In order to protect homes and other buildings, people take steps to make their home be able to withstand and resist the violent forces unleashed by a tropical system. One of the weakest points of any building, whether the building has been built to tough modern standards or was built several years prior, are the windows and glass laden doors. Many windows including windows within doors can be fail due to the pressure loading exerted on the pane when a strong wind acts on the building. The windows on the leeward side of a building experience a substantially lower pressure relative to the pressure within the building. If the window is of insufficient strength, it will be sucked out of its frame in order to achieve pressure equilibrium. Even if the window is of solid construction, unless the pane if made from impact resistant glass, which is extremely expensive to manufacture and install, the window is subject to failure if an object strikes the pane with sufficient force. As a tropical storm or hurricane can blow reasonably large objects around with relative ease, the chances of a window pane breaking during a storm are quite real. Once a window is broken, the storm winds enter into the interior of the building. Such ingressing winds begin to act on the roof of the building and if the winds are of sufficient strength, the roof can be lifted off from the remainder of the building, resulting in catastrophic failure of the building.

In order to guard against window failure, many homeowners place shutters over their windows in a covering relationship in order to protect the windows from both the pressure differential created by the wind and from flying objects that could break the windows. While some people utilize fancy shutters that are either permanently attached to the structure or are retrieved from the garage or attic and attached to preinstalled attachment mechanisms, most people rely on the old standby—plywood. Most people who have been in a storm area just prior to landfall can attest to the lines found at the lumber supply stores around town. The plywood is cut to be of a size that generally corresponds to the window opening and the plywood shutter is placed over the window opening and attached to the building. Attachment is achieved either by directly attaching the plywood shutter to the building, such as by passing a series of screws through the plywood shutter and into the building, or appropriate clips are used, wherein the clips are attached to the building, on the windward side of the plywood shutter, and once so attached, the clips hold the plywood shutter in place within the window opening.

While plywood shutters work reasonably well, and have protected countless structures from the wind forces of a tropical system, use of the plywood shutters requires a destructive intrusion into the building. Once the shutters are removed, the homeowner is left with a series of holes in the building around each window opening. While a series of holes is much better than coming back to a pile of rubble where the building once stood, such holes are unsightly and require repairs.

Accordingly, there exists a need in the art for an attachment system whereby plywood shutters can be secured within a window opening (including a window bearing door) in order to protect the window from wind forces and flying debris, such that the attachment method is non-intrusive to the building. Such a system must be of relatively simple design and construction and must be easy to use so that a building owner can quickly use the system to protect the windows of a building and thereafter evacuate the area. Such an attachment system must not cause damage to the building during use.

### SUMMARY OF THE INVENTION

The storm shutter attachment bar of the present invention addresses the aforementioned needs in the art. The storm shutter retention bar secures a plywood shutter within a window opening of a building in order to allow the plywood shutter to protect the window against wind forces and flying debris. The storm shutter retention bar does not penetrate into or otherwise damage the building upon which the bar is being used. The storm shutter retention bar is of relatively simple design and construction and is relatively quick and easy to use so that a building owner can install several storm shutter retention bars about a building in short order in order to give the owner an opportunity to evacuate the impending storm area.

The storm shutter retention bar of the present invention is comprised of a retention bar that has a first hollow tubular member with a closed first end and an open second end and a second tubular member that has a third end and a fourth end such that the third end is received within the first tubular member so that the second tubular member is partially and slidably received within the first tubular member. A locking mechanism is attached to the first tubular member for selectively preventing sliding of the second tubular member within the first tubular member. A foot is threadably attached to the first end of the first tubular member. A spring is disposed within the first tubular member and has a fifth end that abuts the first end of the first tubular member and a sixth end that abuts the third end of the second tubular member. The retention bar is positioned between a first surface and an opposing second surface of a building such that the first end of the first tubular member abuts against the first surface and the fourth end of the second tubular member abuts against the second surface and such that the spring acts on and loads the first tubular member and the second tubular member and the locking mechanism prevents movement of the second tubular member with respect to the first tubular member and such that the foot is rotated in order to give the retention bar a desired overall length. The foot is capable of pivoting. The locking mechanism comprises a shaft that threadably passes through the first tubular member and frictionally acts on the second tubular member in order to prevent movement of the second tubular member with respect to the first tubular member. A handle is attached to the shaft for rotating the shaft. A first plate member is attached to the fourth end of the second tubular member such that the first plate abuts the second surface of the building. The first plate is positioned in transverse orientation with a longitudinal axis of the second tubular member. A second plate is attached to an outer surface of the second tubular member and is positioned in parallel orientation with a longitudinal axis of the second tubular member and the second plate abuts the shutter. The foot has a first diameter and the first hollow tubular member has a second diameter that is at least as large as the first diameter of the foot. A wrench is used to rotate the foot when the device is deployed in holding a shutter within a building opening. The second hollow tubular member is substantially received within the first hollow tubular member which means that the second tubular member passes at least half way down into the hollow interior of the first tubular member when the device is deployed.

### BRIEF DESCRIPTION OF THE DRAWINGS

FIG. 1 is a perspective view of the storm shutter retention bar of the present invention.

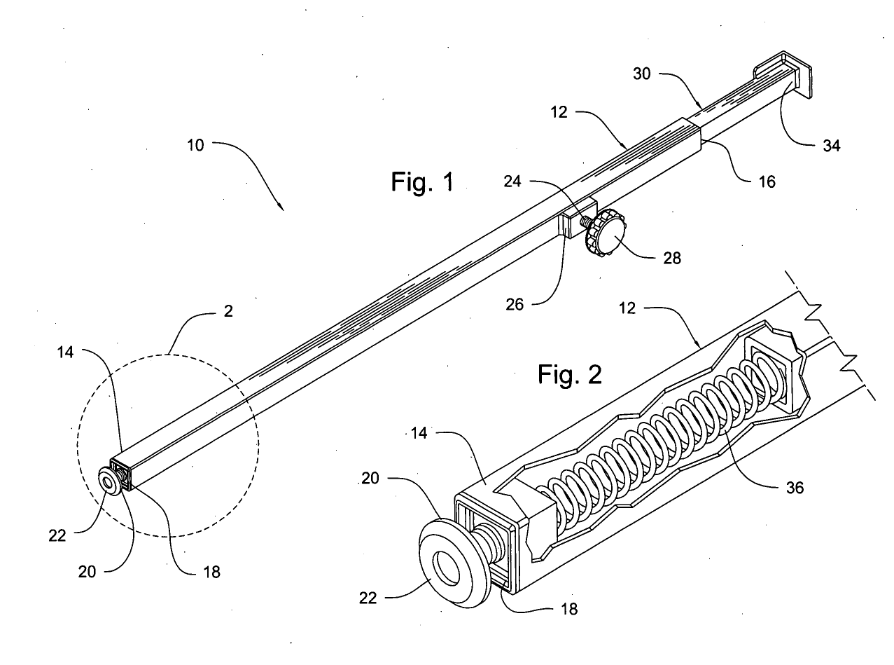

FIG. 2 is a close-up detail view of the storm shutter retention bar.

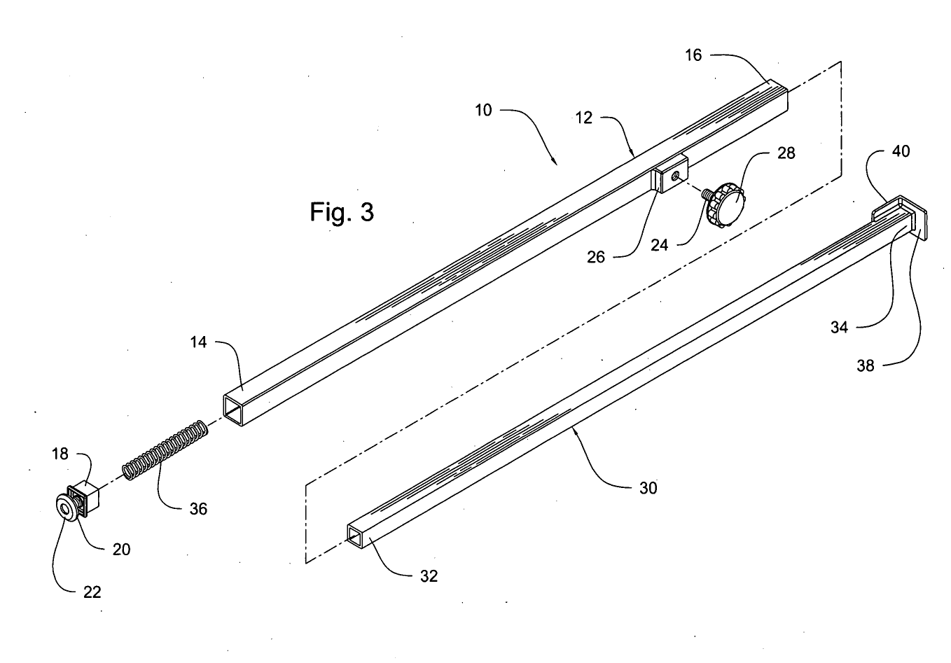

FIG. 3 is an exploded view of the storm shutter retention bar.

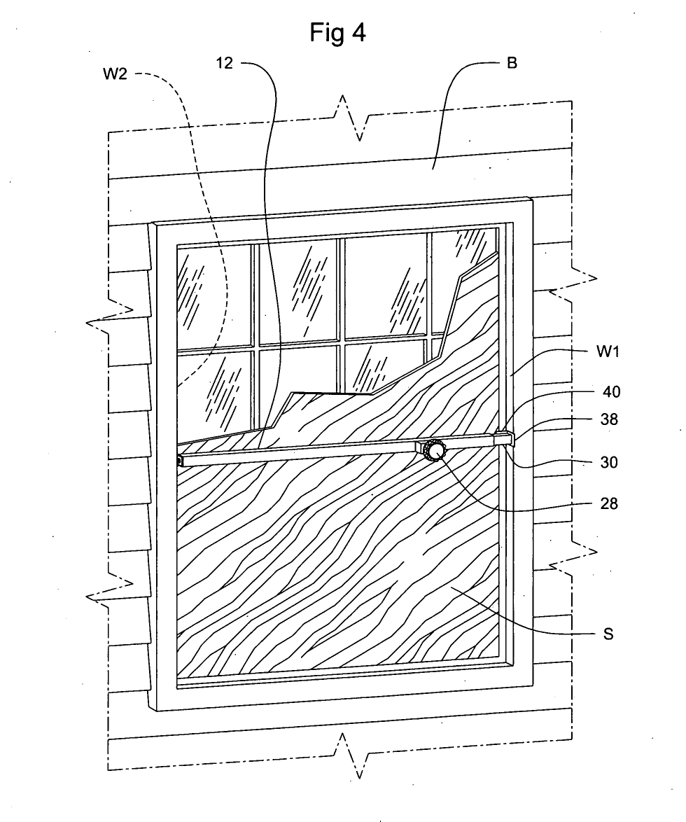

FIG. 4 is an environmental view of the storm shutter retention bar installed on a building.

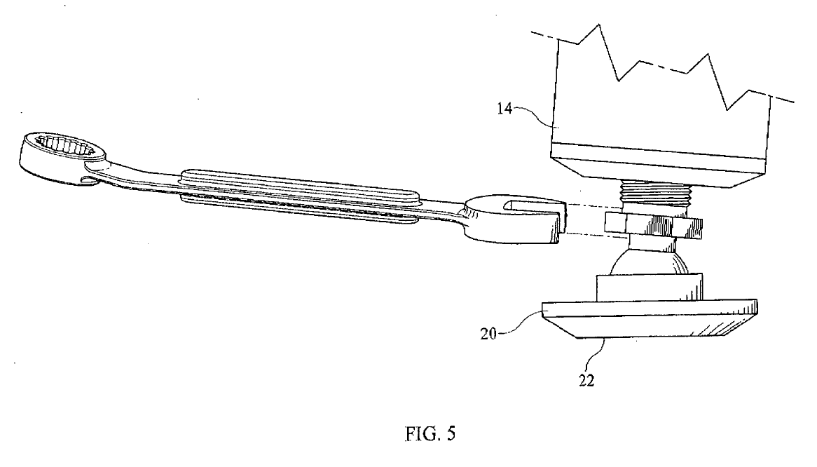

Similar reference numerals refer to similar parts throughout the several views of the drawings.

### DESCRIPTION OF THE PREFERRED EMBODIMENT

Referring now to the drawings, it is seen that the storm shutter retention bar of the present invention, generally denoted by reference numeral 10, is comprised of a first hollow tubular member 12 that has a closed first end 14 and an open second end 16. The closed first end 14 of the first tubular member 12 may be either monolithic and/or integral with the remainder of the first tubular member 12, or as seen, an end cap 18 may be attached, removably or otherwise, to the first tubular member 12 in order to create the closed first end 14. A foot 20 is threadably attached to the end cap 18 (or directly to the first end 14 of the first tubular member 12 in the case of monolithic and/or integral construction). The foot 20 is capable of pivoting and may have a non-slip tip 22 on its end. The diameter of the foot 20 is no greater than the outer diameter of the first tubular member 12. A shaft 24 threadably passes through the first tubular member 12. As the walls of the first tubular member 12 may be relatively thin, a ridge 26 may be provided in order to allow the shaft 24 to appropriately threadably travel through the first tubular member 12, the shaft 24 threadably passing through both the ridge 26 and the first tubular member 12 proper, with the ridge allowing the shaft 24 to maintain proper threaded alignment. A handle 28 is attached to and used to rotate the shaft 24.

A second tubular member 30 is provided and has a third end 32 and a fourth end 34 such that the third end 32 of the second tubular member 30 is received within the first tubular member 12 and a portion of the second tubular member 30 is received within the hollow interior of the first tubular member 12. The second tubular member 30 slides within the first tubular member 12. A spring 36 is disposed within the first tubular member 12 and abuts against the first end 14 of the first tubular member 12 and the third end 32 of the second tubular member 30. A first plate 38 is attached to the fourth end 34 of the second tubular member 30 and is positioned in transverse relationship with the longitudinal axis of the second tubular member 30 while a second plate 40 is attached to an outer surface of the second tubular member 30 and is positioned in parallel relationship with the longitudinal axis of the second tubular member 30. The first plate 38 and the second plate 40 may, but need not be, a single integral unit, such as a piece of angle iron. The first plate 38 and the second plate 40 are attached to the second tubular member 30 in any appropriate manner such as welding or adhering the plates 38 and 40 to the second tubular member 30.

The first tubular member 12 and the second tubular member 30 have substantially similar cross-sections so that the second tubular member 30 slides easily within the first tubular member 12 without any unnecessary sway. The first tubular member 12 and the second tubular member 30 are made from any appropriate material such as metal or hard plastic as is the first plate 38 and the second plate 40. The first tubular member 12, the second tubular member 30, the first plate 38, and the second plate 40, may each have an appropriate protective coating thereon in order to protect each from moisture, etc.

In order to use the storm shutter retention bar 10 of the present invention, the device 10 is assembled by placing the spring 36 into the hollow interior of the first tubular member 12 and thereafter passing the third end 32 of the second tubular member 30 through the open second end 16 of the first tubular member 12. The retention bar 10 is positioned between a first side wall W1 and a second side wall W2 (or top wall and opposing bottom wall) of a window opening of a building B after a shutter S has been placed against the window. The retention bar 10 is dimensioned so that the second tubular member 30 needs to be pressed into the first tubular member 12 against the force of the spring 36 in order for the device 10 to fit between the two side walls W1 and W2 in order to provide an assist during installation. As such, the two tubular members 12 and 30 are acted upon and loaded by the spring 36. The first tubular member 12 and second tubular member 30 are positioned between the two side walls W1 and W2, with the foot 20 contacting the first side wall W1 and the first plate 38 contacting the second side wall W2 and the second plate 40 contacting the shutter S. In this position the second tubular member 30 is substantially received within the first tubular member 12 which means that the second tubular member 30 is received at least half way down within the hollow interior of the first tubular member so that there is substantial overlap of the two tubular members 12 and 30 (at least half of the hollow interior of the first tubular member 12 is filled with the second tubular member) in order to give the device substantial tensile strength. Once in position, the handle 28 is rotated in order to rotate the shaft 24 until the shaft 24 frictionally engages the second tubular member 30 and prevents the second tubular member 30 from sliding with respect to the first tubular member 12, the shaft 24 making a slight indentation upon the second tubular member 30 in order to provide additional holding strength, the use of aluminum for the two tubular members 12 and 30 assisting in this hold. This is the gross length adjustment of the storm shutter retention bar 10. Thereafter, the foot 20 is rotated via a wrench (hand rotation can cause substantial injury due to the confines within which the device 10 is deployed and many people, especially large handed ones, may not be able to gain sufficient dexterity so as to properly tighten the foot 20) in order to make any fine length adjustments of the retention bar 10. Now the storm shutter retention bar 10 is firmly in place and presses against the first wall W1 and the opposing second wall W2. As the storm shutter retention bar's length is locked in place, the device 10 itself is locked in place between the two walls W1 and W2 and the shutter S is held in place thereby. The first plate 38 allows for the retention bar 10 to make good solid contact with the second wall W2 while the second plate 40 allows the device 10 to make good contact with the shutter S. As the diameter of the foot 20 is no greater than the outer diameter of the first tubular member 12, it is the tubular member 12 that makes the solid (and substantial area) contact with the shutter S not necessarily the outer periphery of the foot 20. The foot 20, by being able to pivot, makes allowances for less that square installation of the device 10 and/or opposing walls W1 and W2 that are not entirely parallel with one another, which tends to be the norm not the exception. In order to remove the storm shutter retention bar 10, and thus allow the shutter S to be removed, the handle 28 is counterrotated and the second tubular member 30 is pressed into the first tubular member 12 slightly in order to give the retention bar 10 clearance to be removed from out between the two side walls W1 and W2.

While the invention has been particularly shown and described with reference to an embodiment thereof, it will be appreciated by those skilled in the art that various changes in form and detail may be made without departing from the spirit and scope of the invention.

1. A retention bar comprising:
a first hollow tubular member having a closed first end and an open second end;
a second tubular member having a third end and a fourth end such that the third end is received within the first tubular member so that the second tubular member is partially and slidably received within the first tubular member;
a locking mechanism attached to the first tubular member for selectively preventing sliding of the second tubular member within the first tubular member;
a first plate attached to the fourth end of the second tubular member and positioned in transverse orientation with a longitudinal axis of the second tubular member;
a second plate attached to an outer surface of the second tubular member and positioned in parallel orientation with the longitudinal axis of the second tubular member, the second plate extending from the first plate toward the third end of the second tubular member; and
a foot threadably attached to the first end of the first tubular member, the foot capable of pivoting.

2. (canceled)

3. The retention bar as in claim 1 wherein the locking mechanism comprises:
a shaft threadably passing through the first tubular member and frictionally acting on the second tubular member; and
a handle attached to the shaft for rotating the shaft.

4. The retention bar as in claim 1 further comprising a spring disposed within the first tubular member and having a fifth end abutting the first end of the first tubular member and a sixth end abutting the third end of the second tubular member.

5. The retention bar as in claim 1 wherein the first plate and the second plate are formed from an angle iron.

6. The retention bar as in claim 1 wherein the first hollow tubular member has a rectangular cross-section.

7. The retention bar as in claim 6 wherein the second hollow tubular member has a rectangular cross-section.

8. The retention bar as in claim 1 wherein the foot has a first diameter and the first hollow tubular member has a second diameter that is at least as large as the first diameter.

9. The retention bar as in claim 1 in combination with a wrench that is used to rotate the foot.

10. The retention bar as in claim 1 wherein the second hollow tubular member is substantially received within the first hollow tubular member.

11. A retention device comprising:
a retention bar having first hollow tubular member having a closed first end and an open second end and a second tubular member having a third end and a fourth end such that the third end is received within the first tubular member so that the second tubular member is partially and slidably received within the first tubular member;
a locking mechanism attached to the first tubular member for selectively preventing sliding of the second tubular member within the first tubular member;
a foot threadably attached to the first end of the first tubular member, the foot capable of pivoting;
a spring disposed within the first tubular member and having a fifth end abutting the first end of the first tubular member and a sixth end abutting the third end of the second tubular member;
a first plate attached to the fourth end of the second tubular member and positioned in transverse orientation with a longitudinal axis of the second tubular member;
a second plate attached to an outer surface of the second tubular member and positioned in parallel orientation with the longitudinal axis of the second tubular member, the second plate extending from the first plate along toward the third end of the second tubular member; and
wherein the retention bar is adapted to be positioned between a first surface and an opposing second surface such that the first end of the first tubular member abuts against the first surface and the fourth end of the second tubular member abuts against the second surface and such that the spring acts on the first tubular member and the second tubular member and the locking mechanism prevents movement of the second tubular member with respect to the first tubular member and such that the foot is rotated in order to give the retention bar a desired overall length such that the second hollow tubular member is substantially received within the first hollow tubular member.

12. (canceled)

13. The retention bar as in claim 11 wherein the locking mechanism comprises:
a shaft threadably passing through the first tubular member and frictionally acting on the second tubular member; and
a handle attached to the shaft for rotating the shaft.

14. The retention bar as in claim 11 wherein the first plate and the second plate are formed from an angle iron.

15. The retention bar as in claim 11 wherein the first hollow tubular member has a rectangular cross-section.

16. The retention bar as in claim 11 wherein the second hollow tubular member has a rectangular cross-section.

17. The retention bar as in claim 11 wherein the foot has a first diameter and the first hollow tubular member has a second diameter that is at least as large as the first diameter.

18. The retention bar as in claim 11 in combination with a wrench that is used to rotate the foot.
